(19) United States
(12) Patent Application Publication
(10) Pub. No.: US 2025/0111430 A1
(43) Pub. Date: Apr. 3, 2025

(54) SYSTEMS AND METHODS FOR INTELLIGENT LENDER SELECTION

(71) Applicant: Cox Automotive, Inc., Atlanta, GA (US)

(72) Inventors: Rahul Gupta, Cumming, GA (US); Udit Luthur, Kennesaw, GA (US)

(21) Appl. No.: 18/477,896

(22) Filed: Sep. 29, 2023

(51) Int. Cl. G06Q 40/03

(52) U.S. Cl. CPC G06Q 40/03

(57) ABSTRACT

Methods for intelligent lender selection is provided. A customer identifier associated with a customer is received and customer variables are determined based on the customer identifier. Vehicle variables associated with a vehicle to be transferred to the customer are received. Loan variables associated with a loan application by the customer for transfer of the vehicle to the customer are determined based on the vehicle variables and the customer variables. A probability of acceptance of the loan application by the customer for transfer of the vehicle by each of a plurality of lending entities is predicted based on the loan variables, the vehicle variables, and the customer variables. One or more lending entities are filtered from the plurality of lending entities based on the probability of acceptance and a minimum probability of acceptance defined by an administrator. The loan application is submitted to each of the one or more lending entities.

### BACKGROUND

The vehicle purchasing process can be complex and overwhelming. Consumers who undertake the process first need to select a vehicle at a vehicle dealer from a vast pool of options. After narrowing down to one vehicle from the pool, the customer then proceeds to the financing process. The financing process generally involves the customer providing personal information to Finance and Insurance (F/I) division of the vehicle dealer. Depending on the personal information and a sale price of the selected vehicle, the F&I division determines one or more lending entities to submit a loan application to finance transfer of the vehicle to the customer. The process of determining the lending entities and submitting the loan application may take up to 15-40 minutes. During this time the costumer may be disconnected from the process and left waiting, resulting in 15-20% chances of walking away from the purchase. In addition, manual selection of the lender entities for financing is not efficient and there is inherent human bias resulting in lost potential revenue.

### BRIEF DESCRIPTION OF THE DRAWINGS

The accompanying drawings, which are incorporated in and constitute a part of this disclosure, illustrate various embodiments of the present disclosure. In the drawings:

FIG. 1 is a block diagram of an operating environment for intelligent lender selection;

FIG. 2 is a block diagram of a vehicle transfer system;

FIG. 3 is a flow diagram of a method for intelligent lender selection; and

FIG. 4 is a block diagram of a computing device.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Finance and Insurance (F&I) division of vehicle dealers contribute significantly to dealership profitability when properly managed. For example, by reducing an amount of time required in financing a vehicle transfer, the F&I division can not only reduce a number of customer walkouts, but also increase revenue from the financed vehicle purchases. The disclosure provides processes for intelligent lender selection that reduces an amount of time spent in selecting lenders (also referred to as lending entities) to finance a vehicle transfer. In addition, the disclosed processes to improve a likelihood of approval of a loan application. Moreover, the disclosed processes mitigate human bias in the loan application process.

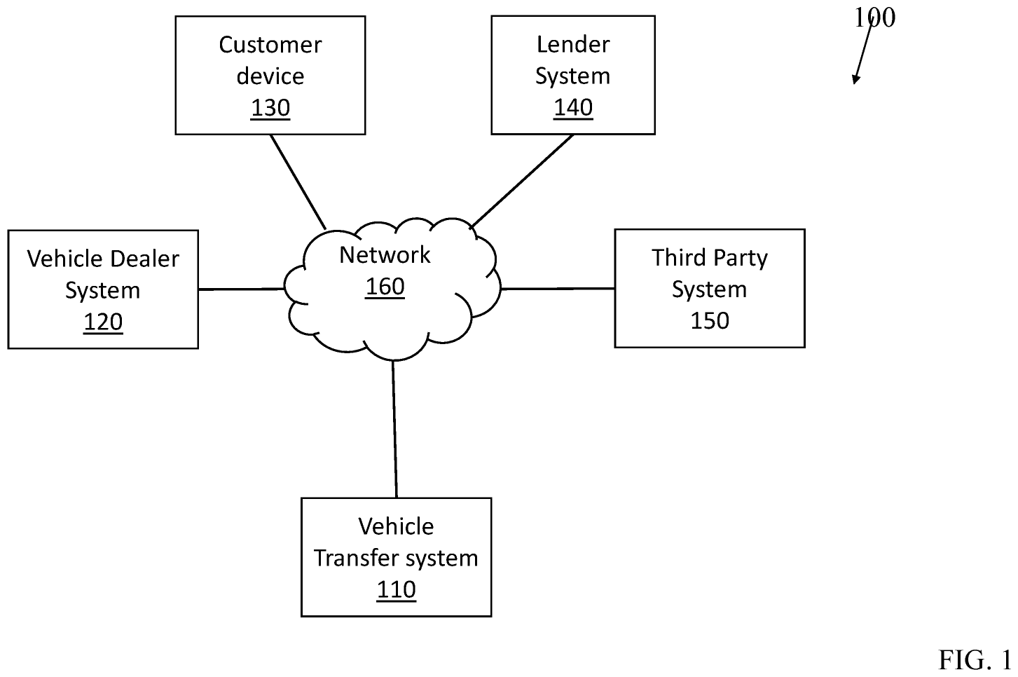

FIG. 1 illustrates an example operating environment 100 for intelligent lender selection in accordance with example embodiments of the disclosure. As shown in FIG. 1, operating environment 100 includes a vehicle transfer system 110, a vehicle dealer system 120, a customer device 130, a lender system 140, and a third party system 150. Operating environment 100 may include multiple instances of one or more of these devices and systems 120 through 150.

Operating environment 100 further includes a network 160 through which systems and devices 110 through 150 may communicate with each other. Network 160 may include any combination of local and/or wide area networks, using both wired and/or wireless communication systems. For example, network 160 includes communication links using technologies such as Ethernet, 802.11, Worldwide Interoperability for Microwave Access (WiMAX), 3G, 4G, 5G, 6G, 7G, Code Division Multiple Access (CDMA), Digital Subscriber Line (DSL), etc. Examples of networking protocols used for communicating via network 160 include Multiprotocol Label Switching (MPLS), Transmission Control Protocol/Internet Protocol (TCP/IP), Hypertext Transport Protocol (HTTP), Simple Mail Transfer Protocol (SMTP), and File Transfer Protocol (FTP). Data exchanged over network 160 may be represented using any suitable format, such as Hypertext Markup Language (HTML) or Extensible Markup Language (XML).

Vehicle transfer system 110 interacts with some or all of the other systems and devices 120 through 150 to perform vehicle transfer transaction. Vehicle transfer transaction may refer to sale or lease of a vehicle from a dealership to a customer of the dealership. Vehicle transfer system 110 may further communicate with some or all of the other systems and devices 120 through 150 to secure one or more forms of financing for the vehicle transfer transaction. More particularly, and as discussed in greater detail in following sections of the disclosure, vehicle transfer system 110 may facilitate intelligent lender selection to expedite financing and maximize a profit in the financing of the vehicle transfer transaction. In addition, vehicle transfer system 110 may facilitate submitting the loan application to selected one or more lenders.

Vehicle dealer system 120 is a computing system operated by a vehicle dealer that provides information about the vehicle dealer, such as contact information for the vehicle dealer, information about one or more vehicles in the possession of the vehicle dealer, lending entities associated with the vehicle dealer, etc. In one embodiment, vehicle dealer system 120 is a web server that provides a publicly available website operated by the vehicle dealer. As referred to herein, a vehicle dealer is an entity that possesses or otherwise has the right to sell, lease, rent, or temporarily transfer control of a vehicle to another entity (e.g., a customer). A vehicle dealer may be a licensed vehicle dealership or vehicle manufacturer (e.g., a business entity) or a solo independent being (e.g., a human entity) that interfaces with vehicle transfer system 110 for transferring control of a vehicle to facilitate a vehicle transfer transaction.

Customer device 130 is a computing device operated by a customer to view the information provided by dealer system 120. Customer device 130 may be a computing device that belongs to the customer, such as a personal laptop computer, desktop computer, tablet computer, or smartphone. Customer device 130 may alternatively be a computing device that a vehicle dealer provides for a customer to use. For example, customer device 130 may be a computing device that is physically located inside a vehicle dealer in a manner that is accessible to customers, which allows a customer to view the information provided by vehicle dealer system 120 during an in-person visit to the vehicle dealer. As referred to herein, a customer is a person or entity that seeks to possess or otherwise buy, lease, rent, or otherwise at least temporarily obtain control of a vehicle from another entity (e.g., a vehicle dealer). A customer may be a licensed vehicle dealership (e.g., a business entity) or a solo independent being (e.g., a person) that may interface with vehicle transfer system 110 for obtaining control of a vehicle to facilitate a vehicle transfer transaction.

Lender system 140 is operated by a lending entity, a bank, or other capital source that seeks to make funds available in a loan to another entity (e.g., to a customer for use in at least temporarily obtaining control of a vehicle from a vehicle dealer) with the expectation that the element of value will be repaid (e.g., within a certain amount of time, in addition to any interest and/or fees, either in increments or as a lump sum). Such a lending entity may be a licensed public or private group or a financial institution (e.g., a business entity or collection of individuals) or a solo independent being (e.g., a human entity) that may interface with vehicle transfer system 110 for making a loan to a customer to facilitate a vehicle transfer transaction.

Third party system 150 provides a third party application or service that processes or provides any suitable subject matter that may be used by any other system or device in operating environment 100 to enable a vehicle transfer transaction. In one embodiment, third party system 150 is operated by a financial institution (e.g., banks) that provides financial information or credit scores for any suitable users or vehicles of the platform. For example, third party system 150 may be operated by an information management service and credit information service, such as TransUnion of Chicago, Ill., Equifax Inc. of Atlanta, Ga., Experian PLC of Dublin, Republic of Ireland, Edmunds.com, Inc. of Santa Monica, Calif., Black Book auto valuation of Heart Business Media Corporation of New York, N.Y., Kelley Blue Book auto valuation of Cox Automotive of Atlanta, Ga., Plaid Technologies, Inc. of San Francisco, Calif., Twilio of San Francisco, Calif., and the like, from which data may be collected by any suitable data hub or Data Management System (“DMS”) and shared with vehicle transfer system 110). Third party system 150 may also include historical loan application data providers (for example, DealerTrack).

As other examples, third party system 150 may be operated by a risk management research entity, an ancillary goods/services provisioning entity, an entity that may provide Vehicle Service Contract (VSC) products and/or F&I products, backup and recovery provider entities, an underwriter, a loan servicer, a financial transaction electronic network, electronic signature facilitator entities, a loan agent, an investor, a social network that provides any suitable connection information between various parties, a government agency/regulator, a licensing body, a third party advertiser, an owner of relevant data, a seller of relevant goods/materials, a software provider, a maintenance service provider, or a scheduling service provider.

Although operating environment 100 and systems and devices 110 through 150 are described herein with respect to the transfer of a vehicle from a vehicle dealer to a customer, operating environment 100 can alternatively be used to transfer a different type of good or service (e.g., a real estate property, business supply, etc.) according to one or more of the concepts described in this disclosure.

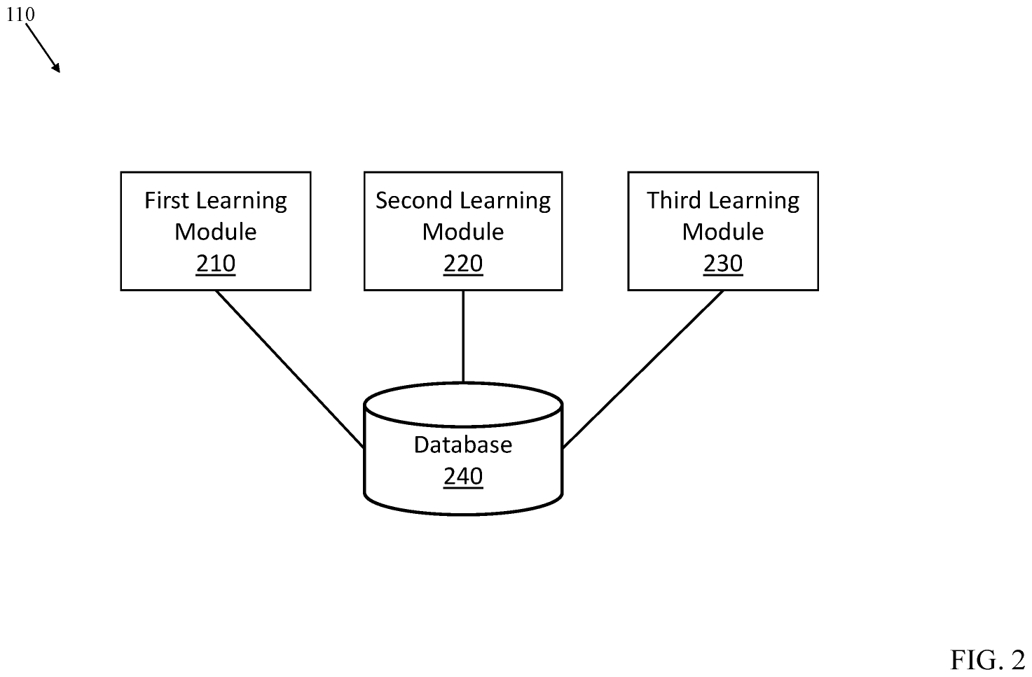

FIG. 2 illustrates vehicle transfer system 110 in accordance with example embodiments of the disclosure. As shown in FIG. 2, vehicle transfer system 110 includes a first learning module 210, a second learning module 220, a third learning module 230, and a database 240. Each of first learning module 210, second learning module 220, and third learning module 230 may be a machine learning module and may include a learning algorithm which is trained using historical data stored in database 240. Historical data may include, for example, loan application data comprising a list of approved/disapproved loan applications, a buy lending rate for each of accepted loan applications, a sale lending rate for each of the accepted loan applications, a customer profile or customer variables associated with each approved/disapproved loan application, a vehicle data or vehicle variables associated with each approve/disapproved loan application, and financial data or loan variables associated with each of approved/disapproved loan applications. Accepted loan applications may include loan applications which resulted in financing of a vehicle transfer transaction. The historical data can be collected from a plurality of lending entities or third party system 150 that collects historical loan application approval data.

First learning module 210, once trained, may predict a probability of acceptance of the loan application by a customer for availing funds for transfer of a vehicle by each of a plurality of lending entities based on the customer variables, the vehicle variables, and the loan variables. Second learning module 220, once trained, may predict a buy lending rate for the loan application from the one or more lending entities based on the customer variables, the vehicle variables, and the loan variables. Third learning module 230, once trained, may predict a sale lending rate of the loan application based on a buy lending rate predicted by second learning module 220. These predictions, as discussed in more detail in the following sections of the disclosure, are used for intelligent lender selection for financing transfer of a vehicle from a vehicle dealer to a customer.

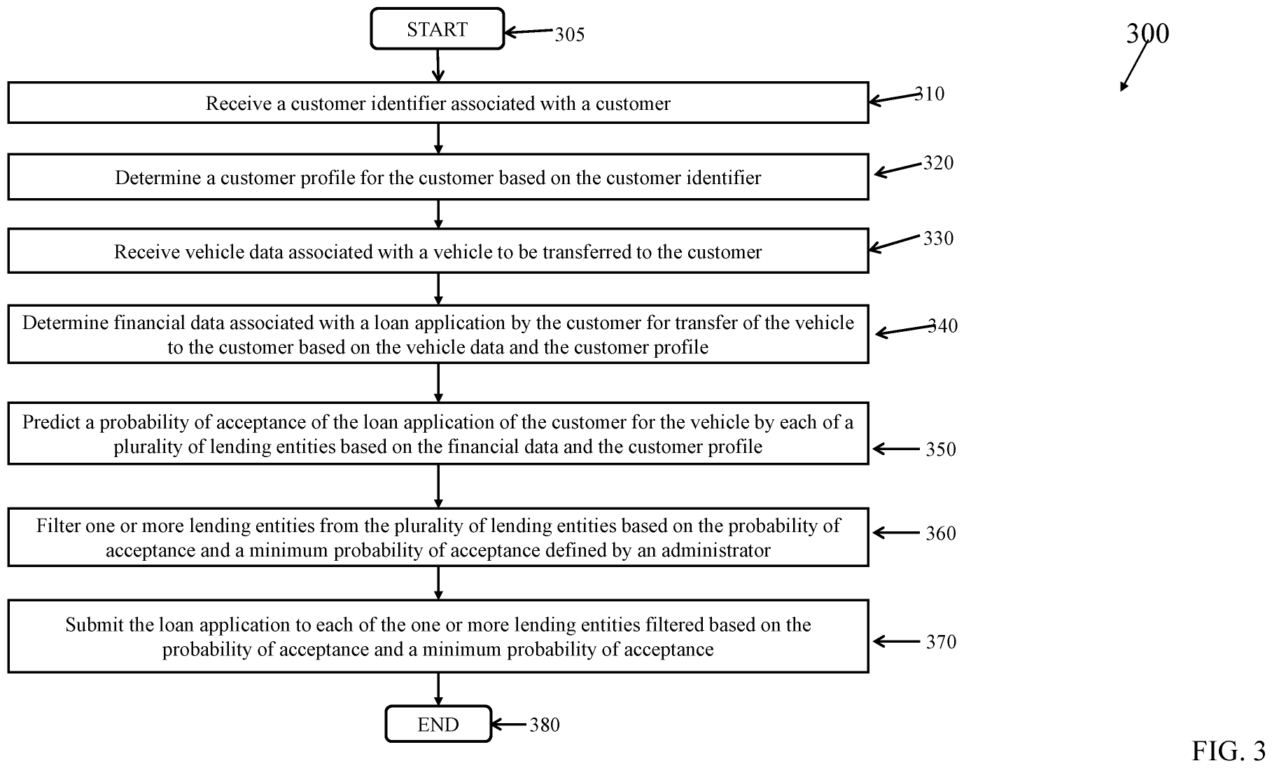

FIG. 3 is a flow chart setting forth the general stages involved in a method 300 consistent with an embodiment of the disclosure for intelligent lender selection. Method 300 may be performed by vehicle transfer system 110 as described in more detail above with respect to FIGS. 1 and 2. Ways to implement the stages of method 300 will be described in greater detail below.

Method 300 begins at starting block 305 and proceeds to stage 310 where a customer identifier associated with a customer is received. The customer identifier can be received by vehicle transfer system 110. For example, a customer can select a vehicle to purchase or lease at a vehicle dealer. The customer can select the vehicle either by surfing through an online listing of vehicles or by physically walking at a vehicle lot of the vehicle dealer. After selecting the vehicle, the customer may decide to buy or lease the selected vehicle through financing. To initiate the financing, the customer may be prompted to provide the customer identifier either to an administrator at the vehicle dealer or by filing an online form through customer device 130. The customer identifier can include a user identification number, a social security number, a driver license number, first/last name, a phone number, etc. In some examples, vehicle transfer system 110 may provide a Graphical User Interface (GUI) to the customer or the administrator to provide or input the customer identifier.

After receiving the customer identifier at stage 310, method 300 may proceed to stage 320 where a customer profile for the customer is determined based on the customer identifier. For example, vehicle transfer system 110 may determine customer variables for the customer based on the customer identifier from vehicle dealer system 120 or third party system 150. The customer profile or the customer variables may include one or more of personal information (e.g., birth date, current and past home addresses, phone numbers, and/or current and past employers, etc.), customer's current income, credit scores, account information (e.g., credit cards, installment loans, mortgages or auto loans, etc.), public records (e.g., bankruptcies), and/or user characteristics (e.g., behavioral driving habit, a residency, age, gender, etc.).

Once having determined the customer profile at stage 320, method 300 proceeds to stage 330 where vehicle data associated with a vehicle to be transferred to the customer is received. For example, vehicle transfer system 110 determines vehicle variables such as a sale price of the vehicle from vehicle dealer system 120. In addition, the vehicle variables can include customer incentives, a dealer rebates trade-in valuation, aftermarket products, dealer pay plans, cost of dealer trade, etc. Moreover, the vehicle variables can further include local market information, geological location of the dealer, dealer goals, etc. Furthermore, the vehicle variables can include one or more features, such as, a make, a model, a year, a vehicle type, a tire type, size, color, number of engine cylinders, etc. the vehicle data is also referred to as vehicle variables.

After determining the vehicle data associated with the vehicle at stage 330, method 300 proceeds to stage 340 where financial data associated with a loan application by the customer for financing the transfer of the vehicle to the customer is determined based on the vehicle data and the customer profile. For example, vehicle transfer system 110 determines loan variables or deal variables associated with the loan application for financing the transfer of the vehicle to the customer. The loan variables may include an amount of credit or funds the customer is seeking in the loan application from a lending entity, an amount of down payment the customer is willing to provide, a length of the loan (i.e., a loan term), a Loan to Value (LTV) ratio for the vehicle, lending entities parameters, etc.

Once having determined the financial data associated with the loan application at stage 340, method 300 proceeds to stage 350 where a probability of acceptance of the loan application for financing the transfer of the vehicle by each of a plurality of lending entities is predicted based on the financial data and the customer profile. For example, first learning module 210 of vehicle transfer system 110, once trained, predicts the probability of acceptance of the loan application for transfer of the vehicle by each of the plurality of lending entities. In some examples, the plurality of lending entities may include every possible lending entity the vehicle dealer works with or has ties with.

First learning module 210 is trained based on the historical loan disapproval data. First learning module 210 may include a learning algorithm, for example, a gradient boosting algorithm. During the training or the learning phase, first learning module 210, for example, builds models sequentially to reduce errors in predictions of a previous model. The new models in the sequence are built based on the errors or residuals of the previous models. In some examples, first learning module 210 includes is a tree-based classification algorithm. For example, during a learning or a training phase, first learning module 210 makes initial set of trees for each inputs and provides or predicts a binary decision as an output for each inputs. For example, a tree based on the credit score may use the credit score as input and is trained to provide an output as yes when the credit score is greater than 700 and if not then provide an output as no. First learning module 210 compares the predicted outcomes from the initial set of trees with historical outcomes and determines an error in prediction from the initial set of trees. First learning module 210 then creates a next set of trees based on the errors in the previous set of trees to reduce the errors in predictions from the previous round. This process of creating new set of trees to reduce the errors in predications in the previous set of trees can be repeated for a number of rounds or when the errors are less than a predetermined level. The administrator can set the number of rounds form the error reduction (for example, 10,000 rounds).

First learning module 210 is trained based on the historical data. For example, database 240 may include historical loan application approval data from the current dealership, from other dealerships in a same geographical area as the current dealership, and from other dealerships in other geographical areas or from all over the country. Database 240 may acquire and retain the historical loan application approval data for a predetermined length of time (for example, 6, month, 1 year, 5 years, etc.) and can constantly update based on new approvals. The historical loan application approval data can include the consumer variables, the deal variables, and the consumer variables for each of approved/disapproved/accepted loan applications. In addition, database 240 may store macro-economic variables, for example, Gross Domestic Product (GDP), inflation, unemployment rate, used vehicle index, etc.

After being trained on the historical loan application approval data, first learning module 210 may predict the probability of acceptance of the loan application for financing the transfer of the vehicle to the customer based on the consumer variables, the deal variables, and the consumer variables for each of the plurality of lending entities the vehicle dealer is associated with. The probability of acceptance can be in a range of 0 to 1. However other ranges are possible. First learning module 210 may use additional variables, for example, the macro-economic variables while predicting the probability of acceptance.

After determining the probability of acceptance of the loan application by each of the plurality of lending entities at stage 350, method 300 proceeds to stage 360 where one or more lending entities are filtered from the plurality of lending entities based on the probability of acceptance and a minimum probability of acceptance. The minimum probability of acceptance is defined by the administrator of the vehicle dealer. A number of lending entities to be filtered can also be predetermined by an administrator. For example, the administrator can define to filter top three lending entities having the probability of acceptance greater than a defined minimum probability of acceptance. The filtered lending entities can be sorted based on the probability of acceptance in increasing or decreasing order.

In accordance with example embodiments, the minimum probability of acceptance is determined by the administrator based on a number of customers the dealership plans to serve versus acceptable look to book ratio (that is, loan approval to disapproval ratio of submitted loan applications). For example, if the minimum probability of acceptance is determined to be high (for example, 0.8), then a number of lending entities with the probability of acceptance greater than the minimum probability of acceptance may be really small or even zero. Hence, the customer may not have a lending entity or enough number of lending entities to submit the loan application to thereby reducing a number of customers that can be served by the dealership. On the other hand, if the minimum probability of acceptance is defined to be low (for example, 0.2), then an approval rate of the loan applications from the dealership may be low thereby effecting a look to book ratio of the dealership. The look to book ratio may affect association or relationship between the lending entities and the dealership.

In accordance with example embodiments of the disclosure, in addition to the probability of acceptance, the one or more lending entities are sorted further based on profitability. Second learning module 220, for example, predicts a buy lending rate for each of the plurality of lending entities. Third learning module 230 predicts a sale lending rate for each of the plurality of entities. The profitability is determined as a difference between the sale lending rate and the buy lending rate. In examples, the sale lending rate is an interest rate that the dealership presents to the customer as the applicable rate for the loan application. The buy lending rate is an interest rate that the lending entity is going to charge the dealership for the loan application. The sale lending rate is presented to the user while the buy lending rate is used for dealership reference.

Second learning module 220, once trained, predicts the buy lending rate based on the consumer variables, the deal variables, and the loan variables associated with the vehicle transfer for each of the plurality of lending entities. Second learning module 220 is trained based on the historical loan approval data including a list of accepted loan applications, the buy lending rate for each of accepted loan applications, and the customer variables, vehicle variables, and the loan variables for each of the accepted loan applications. Second learning module 220 includes a learning algorithm, for example, a gradient boosting algorithm. During the learning or the training phase, second learning module 220 builds models sequentially to reduce errors of a previous model in predictions of the buy lending rate. The new models in the sequence are built based on the errors or residuals of the previous models. After being trained on the historical loan approval data, second learning module 220 may predict the buy lending rate for the loan application for the vehicle transfer by the customer based on the consumer variables, the deal variables, and the consumer variables associated with the vehicle transfer for each of the plurality of lending entities.

Third learning module 230, once trained, predicts the sale lending rate based on the buy lending rate predicted by second learning module 220. Third learning module 230 is trained based on the historical loan approval data including a list of accepted loan applications, the buy lending rate for each of accepted loan applications, and the sale lending rate for each of the accepted loan applications. Third learning module 230 includes a learning algorithm, for example, an nth degree polynomial. In some examples, the learning algorithm includes a seventh-degree polynomial. During the learning or training process, third learning module 230 uses the buy lending rate and the sale lending rate from the accepted loan applications to determine coefficients of the polynomial. After being trained on the historical loan application approval data, third learning module 230 predicts the sale lending rate of the loan application for the vehicle transfer by the customer based on the buy lending rate predicted by second learning module 220 for the loan application.

Once having filtered the one or more entities at stage 360, method 300 proceeds to stage 370 where the loan application is submitted to each of the one or more lending entities filtered based on the probability of acceptance and a minimum probability of acceptance. For example, vehicle transfer system 110 submits the loan application to the one or more lending entities filtered based on the probability of acceptance and the minimum probability of acceptance. In some examples, the administrator at the vehicle dealer may select a default lending entity for the loan application submission. Vehicle transfer system 110 receives the selection of the default lending entity from the administrator and submits the loan application to the default lender entity in addition to the one or more lending entities. After submitting the loan application at stage 370, method 300 may stop at end block 380.

In accordance with example embodiments, method 300 reduces an amount of time spent by a dealership in the lender selection process from 30-45 minutes to less than one minute. The reduction of the time in the lender selection process improves customer retention thereby improving sales. In addition, method 300 mitigates human induced bias in the lender selection process. Furthermore, method 300 improves profit margins and reduces book to look ratio thereby improving lender relations.

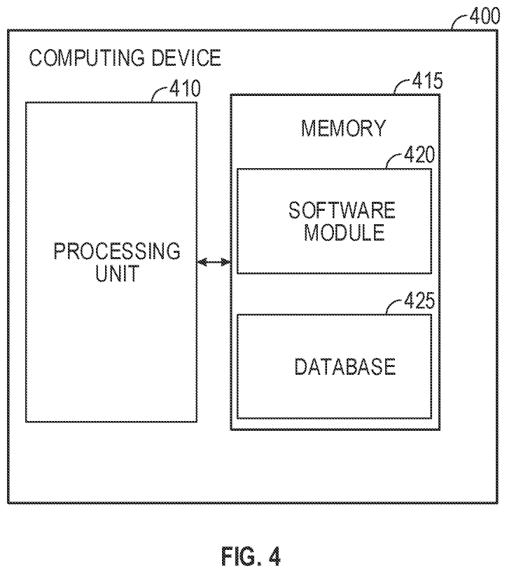

FIG. 4 shows computing device 400. As shown in FIG. 4, computing device 400 includes a processing unit 410 and a memory unit 415. Memory unit 415 includes a software module 420 and a database 425. While executing on processing unit 410, software module 420 performs, for example, processes for intelligent lender selection, including for example, any one or more of the stages from method 300 described above with respect to FIG. 3. Computing device 400, for example, provides an operating environment vehicle transfer system 110, vehicle dealer system 120, customer device 130, lender system 140, and third party system 150. Vehicle transfer system 110, vehicle dealer system 120, customer device 130, lender system 140, and third party system 150 may operate in other environments and are not limited to computing device 400.

Computing device 400 can be implemented using a tablet device, a mobile device, a smart phone, a telephone, a remote control device, a personal computer, a network computer, a mainframe, a router, a switch, a server cluster, a smart TV-like device, a network storage device, a network relay device, or other similar microcomputer-based device. Computing device 400 can include any computer operating environment, such as hand-held devices, multiprocessor systems, microprocessor-based or programmable sender electronic devices, minicomputers, mainframe computers, and the like. Computing device 400 can also be practiced in distributed computing environments where tasks are performed by remote processing devices. The aforementioned systems and devices are examples and computing device 400 can comprise other systems or devices.

Embodiments of the disclosure, for example, can be implemented as a computer process (method), a computing system, or as an article of manufacture, such as a computer program product or computer readable media. The computer program product can be a computer storage media readable by a computer system and encoding a computer program of instructions for executing a computer process. The computer program product can also be a propagated signal on a carrier readable by a computing system and encoding a computer program of instructions for executing a computer process. Accordingly, the present disclosure can be embodied in hardware and/or in software (including firmware, resident software, micro-code, etc.). In other words, embodiments of the present disclosure can take the form of a computer program product on a computer-usable or computer-readable storage medium having computer-usable or computer-readable program code embodied in the medium for use by or in connection with an instruction execution system. A computer-usable or computer-readable medium can be any medium that can contain, store, communicate, propagate, or transport the program for use by or in connection with the instruction execution system, apparatus, or device.

The computer-usable or computer-readable medium can be, for example but not limited to, an electronic, magnetic, optical, electromagnetic, infrared, or semiconductor system, apparatus, device, or propagation medium. More specific computer-readable medium examples (a non-exhaustive list), the computer-readable medium can include the following: an electrical connection having one or more wires, a portable computer diskette, a Random Access Memory (RAM), a Read-Only Memory (ROM), an Erasable Programmable Read-Only Memory (EPROM or Flash memory), an optical fiber, a portable Compact Disc Read-Only Memory (CD-ROM), and a portable pen drive. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIGS. 1 and 3 may be integrated onto a single integrated circuit. Such a SOC device may include one or more processing units, graphics units, communications units, system virtualization units and various application functionality all of which may be integrated (or “burned”) onto the chip substrate as a single integrated circuit. When operating via a SOC, the functionality described herein with respect to embodiments of the disclosure, may be performed via application-specific logic integrated with other components of computing device 400 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

What is claimed:

1. A method comprising:
receiving, by a device comprising at least one processor, a customer identifier associated with a customer;
determining, by the device, a customer profile for the customer based on the customer identifier;
receiving, by the device, a vehicle data associated with a vehicle to be transferred to the customer;
determining, by the device, financial data associated with a loan application by the customer for transfer of the vehicle to the customer based on the vehicle data and the customer profile;
predicting, by a first machine learning module of the device, a probability of acceptance of the loan application for each of a plurality of lending entities based on the financial data and the customer profile;
filtering, by the device, one or more lending entities from the plurality of lending entities based on the probability of acceptance and a minimum probability of acceptance defined by an administrator; and
submitting, by the device, the loan application to each of the one or more lending entities filtered based on the probability of acceptance and a minimum probability of acceptance.

2. The method of claim 1, further comprising:
predicting, by a second machine learning module of the device, a buy lending rate for the loan application from the one or more entities; and
determining, by a third machine learning module of the device, a sale lending rate for the loan application based on the buy lending rate.

3. The method of claim 2, further comprising:
filtering, by the device, the one or more lending entities from the plurality of lending entities further based a profit margin comprising a difference between the sale lending rate and the buy lending rate.

4. The method of claim 2, further comprising:
training the second machine learning module based on historical loan application approval data to predict the buy lending, the historical loan application approval data comprising a list of accepted loan applications, a buy lending rate for each of the accepted loan applications, the customer profile for each of the accepted loan applications, and the financial data for each of the accepted loan applications.

5. The method of claim 2, further comprising:
training the third machine learning module based on historical loan application approval data and the buy lending rate to predict the sale lending rate, the historical loan application approval data comprising a list of accepted loan applications, the buy lending rate for each of the accepted loan applications, and the sale lending rate for each of the accepted loan applications.

6. The method of claim 5, wherein training the third machine learning module comprises determining coefficients of an nth-degree polynomial algorithm based on the historical loan application approval data to predict the sale lending rate.

7. The method of claim 2, wherein the second machine learning module comprises a gradient boosting algorithm.

8. The method of claim 1, further comprising:
training the first machine learning module based on historical loan application approval data to predict the probability of acceptance, the historical loan application approval data comprising a list of approved/disapproved loan applications, the customer profile for each of the approved/disapproved loan applications, and the financial data for each of the approved/disapproved loan applications.

9. The method of claim 8, wherein the first machine learning module comprises a gradient boosting algorithm.

10. The method of claim 1, further comprising:
receiving, by the device, a selection of a default lending entity from the administrator; and
submitting, by the device, the loan application to the default lending entity in addition to the one or more lending entities.

11. A system comprising:
a memory storage; and
a processing unit, the processing unit disposed in a station and coupled to the memory storage, wherein the processing unit is operative to:
receive a customer identifier associated with a customer;
determine customer variables for the customer based on the customer identifier;
receive vehicle variables associated with a vehicle to be transferred to the customer;
determine loan variables associated with a loan application by the customer for financing the transfer of the vehicle to the customer based on the vehicle variables and the customer variables;
predict, by a first machine learning module, a probability of acceptance of the loan application by each of a plurality of lending entities based on the loan variables, the vehicle variables, and the customer variables;
filter one or more lending entities from the plurality of lending entities based on the probability of acceptance and a minimum probability of acceptance defined by an administrator; and
submit the loan application to each of the one or more lending entities filtered based on the probability of acceptance and a minimum probability of acceptance.

12. The device of claim 11, wherein the processing device is further operative to:
predict, using a second machine learning module, a buy lending rate for the loan application from the one or more entities; and
determine, using a third machine learning module, a sale lending rate for the loan application based on the buy lending rate.

13. The device of claim 12, wherein the processing device is further operative to:
filter the one or more lending entities from the plurality of lending entities further based on a profit margin comprising a difference between the sale lending rate and the buy lending rate.

14. The device of claim 12, wherein the processing device is further operative to:
train the second machine learning module based on a historical loan application approval data to predict the buy lending rate, the historical loan application approval data comprising a list of accepted loan applications, a buy lending rate for each of the accepted loan applications, the loan variables for each of the accepted loan applications, the vehicle variables for each of the accepted loan applications, and the customer variables for each of the accepted loan applications.

15. The device of claim 11, wherein the processing unit is further configured to:
train the first machine learning module based on historical loan application approval data to predict the probability of acceptance, the historical loan application approval data comprising a list of approved/disapproved loan applications, the loan variables for each of the approved/disapproved loan applications, the vehicle variables for each of the approved/disapproved loan applications, and the customer variables for each of the approved/disapproved loan applications.

16. The device of claim 11, wherein the first machine learning module comprises a gradient boosting algorithm.

17. A non-transitory computer-readable medium that stores a set of instructions which when executed perform a method executed by the set of instructions comprising:
receiving, by a device comprising at least one processor, a customer identifier associated with a customer;
determining, by the device, a customer profile for the customer based on the customer identifier;
receiving, by the device, a vehicle data associated with a vehicle to be transferred to the customer;
determining, by the device, financial data associated with a loan application by the customer for the transfer of the vehicle to the customer based on the vehicle data and the customer profile;
predicting, by a first machine learning module of the device, a probability of acceptance of the loan application by the customer for transfer of the vehicle by each of a plurality of lending entities based on the financial data and the customer profile;
filtering, by the device, one or more lending entities from the plurality of lending entities based on the probability of acceptance and a minimum probability of acceptance defined by an administrator; and
submitting, by the device, the loan application to each of the one or more lending entities filtered based on the probability of acceptance and a minimum probability of acceptance.

18. The non-transitory computer-readable medium of claim 17, further comprising:
predicting, a second machine learning module of the device, a buy lending rate for the loan application from the one or more entities; and
determining, using a third machine learning module of the device, a sale lending rate for the loan application based on the buy lending rate.

19. The non-transitory computer-readable medium of claim 17, further comprising:
training the first machine learning module based on historical loan application approval data to predict the probability of acceptance, the historical loan application approval data comprising a list of approved/disapproved loan applications, the customer profile associated with each of the approved/disapproved loan application, the vehicle data associated with each of the approved/disapproved loan applications, and the financial data associated with each of the approved/disapproved.

20. The non-transitory computer-readable medium of claim 17, wherein the first machine learning module comprises a gradient boosting algorithm.
